(19) United States
(12) Patent Application Publication
(10) Pub. No.: US 2010/0190013 A1
(43) Pub. Date: Jul. 29, 2010

(54) DETACHABLE ADHESIVE CONTAINING REACTION PRODUCT OF OXIDIZING AGENT AND AMINE COMPOUND

(75) Inventor: Masahiko Sugimoto, Tokyo (JP)

Correspondence Address: GREENBLUM & BERNSTEIN, P.L.C., 1950 ROLAND CLARKE PLACE, RESTON, VA, 20191, US

(73) Assignee: ASAHI KASEI CHEMICALS CORPORATION, Tokyo (JP)

(21) Appl. No.: 12/668,923

(22) PCT Filed: Jul. 18, 2008
(86) PCT No.: PCT/JP2008/063011

§ 371 Date: Jan. 13, 2010

(30) Foreign Application Priority Data
Jul. 19, 2007 (JP) 2007-187801

(51) Int. Cl. B32B 7/06; C09J 201/00; C09J 163/00; C09J 11/06; C08L 63/00; C08L 75/04

(52) U.S. Cl. 428/414; 428/704; 156/344; 428/423.1; 523/400; 524/589

(57) ABSTRACT

Disclosed is a detachable adhesive containing an organic adhesive component and a reaction product which is obtained by reacting an onium salt containing an oxidizing anion with an amine group of an amine compound at a reaction ratio of not less than 50%.

### TECHNICAL FIELD

The present invention relates to a disassemblable adhesive which enables articles to be simply disassembled at their bonded portions, or a structural body assembled with the adhesive.

### BACKGROUND ART

Adhesives have been demanded which have stronger adhesive force and longer durability, and are strong in heat resistance as well as the variations in temperature environment, including structural adhesives, and have been developed. However, from the viewpoint of recycling aiming to effectively use limited resources, the development of a disassemblable adhesive is essential in order to reutilize assembled components.

The disassemblable adhesive refers to an adhesive whereby articles attached by using the adhesive can be separated at their bonded portion by subjecting the articles to some treatment after a use period.

Thermoplastic adhesives as such an adhesive allow bonded portions to be disassembled by heating, but again revive the adhesive force when once cooled. Since it is difficult to heat only an adhesive in disassembly, the disassembly is carried out at a high atmospheric temperature, but the disassembly of a bonded object whose temperature has become high has a high risk.

In order to solve the problem, a heat expansible microballoon, a heat expansible graphite, a decomposable polymer (polyperoxides), or the like, applicable also to thermosetting adhesives which require a higher adhesive force than thermoplastic adhesives, has been developed (see NON-PATENT DOCUMENT 1). However, the heat expansible microballoon still has low heat resistance and initial adhesive strength; and the heat expansible graphite is difficult to use as a practical adhesive because of its large particle diameter, and has such a remaining problem that the heating temperature at disassembly is high (see DOCUMENT 2).

Also an oxidizing agent-mixed adhesive applicable to thermosetting adhesives has been developed (see DOCUMENT 3). The disassembling temperature of the oxidizing agent-mixed adhesive described in DOCUMENT 3 depends on the decomposition temperature of the oxidizing agent. Since the oxidizing agent has a relatively high sensitivity, it has a safety-related problem of necessitating caution in handling thereof at being mixed with an adhesive. Further, in the case of using an adhesive containing an amine hardener, depending on the kind of an oxidizing agent, since air bubbles generated by a reaction of the oxidizing agent and the hardener during curing remain in the adhesive layer, there arises a problem that the initial strength decreases.

### NON-PATENT DOCUMENT 1: Chiaki Sato, Kobunshi (Polymer (in Japanese)), June, 2005, p. 390

### PATENT DOCUMENT 2: JP 2004-189856 A

### PATENT DOCUMENT 3: WO 2007/083566 A1

### DISCLOSURE OF THE INVENTION

### Problems to be Solved by the Invention

It is an object of the present invention to provide an adhesive which has high safety during mixing thereof by adding to an organic adhesive a reaction product, having higher safety than an onium salt in itself containing an oxidizing anion, obtained by reacting the onium salt containing the oxidizing anion with an amine group, and which is capable of suppressing a decrease in the initial strength by suppressing foaming by a reaction of the amine group with the onium salt containing the oxidizing anion in the organic adhesive containing an amine group.

### Means for Solving the Problems

As a result of exhaustive studies to overcome the problems in the above-mentioned conventional technologies, the present inventors have found that by making a reaction product of an onium salt containing an oxidizing anion with an amine compound contained in an organic adhesive containing an amine group, foaming generated during curing is suppressed and a decrease in the initial strength of the adhesive is reduced. These findings have led to the completion of the present invention.

The present invention provides a disassemblable adhesive containing a reaction product of an amine compound with an onium salt containing an oxidizing anion, a method for manufacturing the adhesive, and a method for curing the adhesive, as described below.

(1) A disassemblable adhesive comprising an organic adhesive component; and
a reaction product obtained by reacting an onium salt containing an oxidizing anion with an amine compound such that the reaction ratio of an amine group of the amine compound becomes 50% or higher.
(2) The disassemblable adhesive according to (1), wherein the organic adhesive component is an organic adhesive component containing an amine group.
(3) The disassemblable adhesive according to (1) or (2), wherein the organic adhesive component comprises an epoxy or urethane base resin, and an amine hardener.
(4) The disassemblable adhesive according to (1), wherein the onium salt is at least one selected from the group consisting of perchlorates, chlorates, nitrates and nitrites.
(5) A structural body, obtained by binding an adherend part A and an adherend part B with a disassemblable adhesive according to any one of (1) to (4).
(6) A method for disassembling a structural body according to (5), comprising eliminating or reducing an adhesive strength by an external stimulus.
(7) The method for disassembling a structural body according to (6), wherein the external stimulus is heating.

### ADVANTAGES OF THE INVENTION

The present invention has advantages of: having high safety during mixing by adding to an organic adhesive a reaction product, having higher safety than an onium salt in itself containing an oxidizing anion, obtained by reacting the onium salt containing the oxidizing anion with an amine group; suppressing a decrease in the initial strength by reducing foaming in the adhesive using an amine hardener; and easily disassembling a bonded structural body by an external stimulus and being capable of disassembling it at 280° C. or lower.

### BEST MODE FOR CARRYING OUT THE INVENTION

The disassemblable adhesive according to the present invention comprises a reaction product (hereinafter, also referred to as a disassembling component) of an onium salt containing an oxidizing anion with an amine group of an amine compound.

Amine compounds used in the present description refer to compounds having one or more functions of a primary amine or a secondary amine in a molecule thereof. Monofunctional amines are exemplified by aromatic monofunctional amines such as benzylamine, dibenzylamine, diethylbenzylamine and N-isopropylbenzylamine, aliphatic monofunctional amines such as acetylmethylamine, propylamine, butylamine, t-butylamine and pentylamine, and cyclic monofunctional amines such as cyclohexylamine, cyclobutylamine and cyclopentanemethylamine. Polyfunctional amines include diamines such as meta-xylenediamine, benzylethyldiamine, triethylenediamine and butanediamine, triamines such as diethylenetriamine and pentamethyldiethylenetriamine, and polyamines such as aliphatic polyamines and aromatic polyamines. Amide compounds such as dicyandiamide may be included. Amine compounds are preferably liquid ones because of having a good reactivity with an onium salt containing an oxidizing anion.

An oxidizing anion used in the present invention refers to an “anion to donate oxygen”, and needs to release oxygen by an external stimulus and react with an amine compound to be incorporated as a salt in a disassembling component. They specifically include perchlorate ions, chlorate ions, nitrate ions, nitrite ions. These oxidizing anions may be used in combination of two or more thereof.

An onium ion used in the present invention is a compound ion produced by coordinate-bonding a compound containing an atom having a lone electron pair with another cationic reagent or the like, and includes an ammonium ion [R₃NR′]⁺, a phosphonium ion [R₃PR′]⁺, an arsonium ion [R₃AsR′]⁺, a stibonium ion [R₃SbR′]⁺, and an oxonium ion [R₃OR′]⁺, a sulfonium ion [R₃SR′]⁺, a selenonium ion [R₃SeR′]⁺, a stannonium ion [R₃SnR′]⁺, and an iodonium ion [R₃IR′]⁺.

Therefore, onium salts containing an oxidizing anion specifically include perchlorates (for example, ammonium perchlorate), chlorates (ammonium chlorate and the like), nitrates (ammonium nitrate and the like), and nitrites. These may be used in combination of two or more thereof.

An onium salt containing an oxidizing anion preferably exothermically decomposes under a closed condition. Since an adhesive is disassembled by the thermal decomposition of the adhesive and the onium salt containing the oxidizing anion, use of the onium salt containing the oxidizing anion to exothermally decompose in the closed condition can promote the disassembly of the adhesive. An onium salt containing an oxidizing anion to exothermally decompose in a closed condition, mentioned here, refers to an onium salt containing an oxidizing anion to exothermally decompose when measured by a differential scanning calorimeter using a closed cell.

A disassembling component preferably exothermally decomposes in a closed condition. Since an adhesive is disassembled by the thermal decomposition of the adhesive and the disassembling component, use of a reaction product to exothermally decompose in the closed condition can promote the disassembly of the adhesive. A reaction product to exothermally decompose in a closed condition, mentioned here, refers to a disassembling component to exothermally decompose when measured by a differential scanning calorimeter using a closed cell.

A perchlorate oxidizing agent, particularly ammonium perchlorate used as an oxidizing agent for rockets exothermally decomposes in a closed condition, is easily available, and more preferably has high safety when the agent needs to be crushed (when the agent is mixed in an adhesive, or when the viscosity of an adhesive is regulated). A nitrate, whose decomposed gas is composed mainly of nitrogen, is preferable in view of the environment.

Since a too large particle diameter of an onium salt containing an oxidizing anion to be reacted worsens the reactivity, the diameter is preferably 1 mm or less. Since a fine particle diameter thereof increases the surface area, and improves the reactivity with an adhesive, the diameter is more preferably 100 μm or less, much more preferably 50 μm or less, still more preferably 20 μm or less, even more preferably 10 μm or less, and yet more preferably 5 μm or less. The particle diameter used in the present description refers to a median diameter measured using a laser diffraction particle size distribution analyzer.

The reaction temperature of an onium salt containing an oxidizing anion and an amine compound is preferably not more than the decomposition temperature of the onium salt containing the oxidizing anion in consideration of the safety, and more preferably not more than the boiling point of the amine compound. The reaction time is preferably not less than a time at which the reaction of a disassembling component completely finishes.

The curing temperature of the disassembling component and the adhesive is not any more limited in the case where an onium salt containing an oxidizing anion has completely reacted, but is set preferably at not more than the decomposition temperature of the disassembling component; in the case where the onium salt containing the oxidizing anion has not completely reacted, since curing at not less than the reaction temperature may generate foams, the curing temperature is set preferably at not more than the reaction temperature of the onium salt containing the oxidizing anion and an amine hardener. In short, curing is carried out preferably at a temperature not to cause foaming. The presence of unreacted amines in the hardener and the onium salt containing unreacted oxidizing anions does not matter as long as foaming does not occur during curing.

The amount of an onium salt containing an oxidizing anion is preferably not more than an amount to completely react with a hardener from the viewpoint of suppressing foaming. Further, the amount is preferably not more than an amount to completely react also from the viewpoint that the reacted disassembling component has a higher molecular weight, is a more stable molecule and is a safer substance than the onium salt containing the oxidizing anion. This does not apply to the case where curing is carried out at not more than the reaction temperature even in the case where the reaction is not complete. The reaction ratio of the disassembling component is preferably 50% or higher, more preferably 70% or higher, and still more preferably 90% or higher, from the viewpoint of the safety and the suppression of foaming. The reaction ratio used here refers to one obtained by the measurements of the weight reduction after the reaction and FT-IR, GC-MS and the like before and after the reaction.

Adhesive components to be utilized in the present invention are not any more limited as long as they are organic adhesives containing an amine group, but structural adhesives are preferably used because the gist according to the present invention lies in disassembling objects which can be hardly disassembled. The structural adhesives refers to “adhesives having a guaranteed reliability in which the adhesives do not break for a long period of time and a stress relatively near the maximum breaking load can be applied thereto” (see the classification of adhesives, in Setchaku Ouyou Gijutsu (Adhesion Application Technology (in Japanese)), published by Nikkei Publishing, Inc., 1991, p. 93), and are preferably thermosetting alloys according to the classification with respect to the chemical compositions (the same book as above, p. 99).

Organic adhesive components usable for the disassemblable adhesive according to the present invention are exemplified by adhesives composed mainly of a vinyl acetate resin, a polyamide resin, a polyurethane resin, a polyester resin, a urea resin, a melamine resin, a resorcinol resin, a phenol resin, an epoxy resin, a polyimide resin, a polybenzimidazole, an acryl (SGA), an acrylic acid diester and a silicone rubber. Alloys usable are epoxy phenolic, epoxy polysulfide, epoxy nylon, nitrile phenolic and chloroprene phenolic vinyl phenolic resins or the like, or modified resins thereof, or mixed resins of two or more thereof.

Particularly epoxy resin adhesives cure without liberating by-products, and have a high shearing strength, which is preferable. Bisphenol A epoxy resins and bisphenol F epoxy resins are especially preferable in view of reactivity and workability.

In the case of a structural adhesive, it preferably exhibits a tensile strength of 10 MPa or higher when the measurement of tensile strength as shown in Examples is conducted at room temperature.

A hardener used for an epoxy resin adhesive is not any more limited, but an amine hardener or an amide hardener is preferable in view of a structural adhesive.

Amine hardeners are exemplified by aliphatic polyamines such as diethylenetriamine, triethylenetetramine, tetraethylenepentamine, m-xylenediamine, trimethylhexamethylenediamine, 2-methylpentamethylenediamine and diethylaminopropylamine, alicyclic polyamines such as isophoronediamine, 1,3-bisaminomethylcyclohexane, bis(4-aminocyclohexyl)methane, norbornenediamine, 1,2-diaminocyclohexane and laromine, aromatic polyamines such as diaminodiphenylmethane, meta-phenylenediamine and diaminodiphenylsulfone, and others such as polyoxypropylenediamine, polyoxypropylenepolyamine, polycyclohexylpolyamine mixtures and N-aminoethylpiperazine, and may be those partially modified. Further, they may be amides such as dicyandiamide. Amine hardeners are preferably ones which are liquid at room temperature because these have high reactivity with an onium salt containing an oxidizing anion. These may be used singly or as a mixture of two or more thereof. A disassembling component may be reacted with these amine hardeners and chemically incorporated in a cured body, or may be reacted with an amine compound which is not a hardener, and physically incorporated therein.

The aspect of a disassembling component may be liquid or solid. In the case of a solid, the component may be crushed in order to be homogeneously mixed. The solid has a particle diameter of preferably 1 mm or less from the viewpoint of the dispersibility. The particle diameter is, in consideration of the thickness of an adhesive as well, more preferably 100 μm or less, much more preferably 50 μm or less, still more preferably 20 μm or less, even more preferably 10 μm or less, and yet more preferably 5 μm or less. In the case where the component is liquid, since it disperses well in an adhesive, it is easily homogenously mixed.

The order of the manufacture/addition of a disassembling component and the additions of a base resin and a hardener as adhesive components is not especially limited as long as the homogeneous mixing is possible and foaming generated during curing can be suppressed. For example, it is preferable because foaming during curing can effectively be suppressed that “an onium salt containing an oxidizing anion” and an amine compound are allowed to previously react to obtain a disassembling component, and thereafter, a base resin and a hardener are added. Or, it is also preferable because foaming during curing can be suppressed that a large amount of an amine hardener and “an onium salt containing an oxidizing anion” are first mixed and allowed to react to obtain a disassembling component, and a base resin (for example, an epoxy base resin) is then added and an unreacted amine hardener as the remainder is utilized as a hardener.

It is also allowed that after a base resin and a hardener are mixed, a disassembling component is added, or that all of a base resin and a hardener and a disassembling component are simultaneously mixed. It is also allowed that after a base resin and a disassembling component are mixed, a hardener is added, or that after a hardener and a disassembling component are mixed, a base resin is added.

Since the adhesion of the disassemblable adhesive according to the present invention reduces or eliminates by an external stimulus, a bonded structural body adhered with the adhesive can easily be disassembled.

An external stimulus used in the present description refers to a physical stimulus such as heat or fire, and specifically includes hot air heating, infrared irradiation, high-frequency heating, chemical reaction heating, frictional heating and fire heating by a gas burner or the like. If an above-mentioned stimulus is imparted to a bonded structural body adhered with the adhesive according to the present invention, in addition to a phenomenon that a rise in the temperature of the adhesive decreases the adhesive force the adhesive component has, the reception of the external stimulus encourages oxygen in the hardener (the hardener, a curing accelerator) to thermally decompose/burn the adhesive, and more promotes the carbonization of the adhesive than the case where there is no addition of an onium salt containing an oxidizing anion, which can largely reduce or eliminate the adhesive force.

With respect to uniform heating of a large-sized bonded structural body, methods, including electric furnaces and gas furnaces, are more preferable in which a structural body is heated in the internal space of a heating furnace whose internal structure has a heating section and whose exterior is constituted of a heat insulating material. With respect to metal/FRP jointed bodies, FRP/FRP jointed bodies and the like, it is a very important problem that the temperature at disassembling enables disassembly at a melting point or lower of an FRP and in a short time. For example, in disassembling bonded structural bodies of resins used for composite materials, such as PPS (polyphenylene sulfide, melting point: 280° C.) and PEEK (polyether ether ketone, melting point: 335° C.), in consideration of the reuse, it is important for not inviting the degradation of a resin that the resin is not heated at a temperature of a melting point or higher thereof for a long time; the heating temperature is preferably 350° C. or lower, and more preferably 300° C. or lower.

In the present invention, a decomposition accelerator may be added to an adhesive together with the disassembling component.

A decomposition accelerator used in the present description refers to a substance to promote the decomposition reaction of the disassembling component when used concurrently with the hardener, and a substance to promote the decomposition of the disassembling component due to the catalytic action of decomposing the disassembling component and the improvement in the thermal conductivity.

For example, the decomposition of ammonium nitrate is known to be promoted by a chromate; and the decomposition of ammonium perchlorate, by MnO₂ and Fe₂O₃ (see “Rocket Engineering”, published by The Nikkan Kogyo Shimbun, Ltd., Mar. 25, 1960, pp. 230-231). Additionally, normal butylferrocene (nBF), dinormal butylferrocene (DnBF), FeO(OH) and the like are known (see Itsurou Kimura, “Rocket Engineering”, published by Yokendo Co., Ltd., Jan. 27, 1993, p. 523).

Since a decomposition accelerator is used concurrently with a disassembling component, and mixed with an adhesive, it is preferably solid powdery or liquid at room temperature. Further, since the decomposition accelerator is to promote the decomposition of the disassembling component utilizing a good thermal conductivity of a metal as its function, the decomposition accelerator is preferably a compound containing a metal. Specifically, in addition to the compounds described in the above reference documents, metal oxides such as ferrous oxide, magnesium oxide, copper oxide, cobalt oxide and copper chromite, and compounds containing a metal in a molecule thereof, such as ferrocene, dimethylferrocene and ferrosilicon, which all can be made powdery, can be used. Also usable is active carbon having a catalytic action due to a fine surface structure thereof. These may be used in combination of two or more thereof.

In the present invention, an exothermic agent may be contained in an adhesive together with a disassembling component, or a disassembling component and a decomposition accelerator. An exothermic agent used in the present description refers to one which decomposes while generating heat when its temperature reaches the decomposition temperature of itself, and can promote thermal decomposition/combustion of an adhesive containing the disassembling component or the disassembling component and the decomposition accelerator, and can reduce the atmosphere temperature when an adhesive containing the disassembling component or the disassembling component and the decomposition accelerator is disassembled.

Exothermic agents usable are specifically substances containing an azido group such as 3-azidomethyl-3-oxetane polymer (AMMO), glycidylazide polymer (GAP) and 3,3-bisazidomethyloxetane polymer (BAMO), and besides, azodicarbonamide and metal salts of azodicarbonamide, guanidine nitrate, biscarbamoylhydrazine, p,p′-oxybisbenzenesulfonyl hydrazide, dinitropentamethylenetetramine, p-toluenesulfonyl hydrazide, benzenesulphonyl hydrazide, dinitropentamethylenetetramine, trimethylenetrinitroamine (RDX), tetramethylentetranitramine (HMX), urazole, triazoles, tetrazoles, and the like.

In order that these exothermic agents promote the thermal decomposition/combustion of an adhesive containing a disassembling component or a disassembling component and a decomposition accelerator, and reduce the disassembling temperature as described above, the decomposition temperature of the exothermic agents is preferably nearly equal to or lower than the decomposition temperature of the disassembling component.

A decomposition accelerator and an exothermic agent may be previously contained in an adhesive component, or may be mixed when an adhesive is used if there is a problem with long-period stability in the adhesive before curing.

With respect to the addition amount of an onium salt containing an oxidizing anion, the weight ratio of an adhesive component and the onium salt containing the oxidizing anion is preferably 100/1 to 2/3 from the viewpoint of the disassemblability, the initial strength of an adhesive, and the viscosity of the adhesive. With the weight ratio in this range, there is no decrease in disassemblability due to a too small amount of an onium salt containing an oxidizing anion; and there is no reduction in the initial strength of an adhesive and no remarkable rise in the viscosity of the adhesive due to a too large amount of the onium salt containing the oxidizing anion. The more preferable weight ratio of an adhesive component and an onium salt containing an oxidizing anion is 75/1 to 2/1, and the still more preferable one is 50/1 to 3/1.

In the case of adding a decomposition accelerator, the weight ratio of an onium salt containing an oxidizing anion and the decomposition accelerator is preferably 50/1 to 1/5 from the viewpoint of the disassemblability and the thermal resistance of an adhesive. The weight ratio in this range can provide an effective decomposition promoting effect and exhibits no decrease in the thermal resistance of an adhesive. The more preferable weight ratio of an onium salt containing an oxidizing anion and a decomposition accelerator is 45/1 to 1/3, and the still more preferable one is 40/1 to 1/2.

In the case of adding an exothermic agent, the weight ratio of an onium salt containing an oxidizing anion and an exothermic agent is preferably 1/1 to 1/100 from the viewpoint of the disassemblability. The more preferable weight ratio of an onium salt containing an oxidizing anion and an exothermic agent is 1/2 to 1/80, and the still more preferable one is 1/3 to 1/50.

Even in the case of concurrently using a disassembling component, a decomposition accelerator and an exothermic agent, the weight ratio of an adhesive component and the total weight of the disassembling component, the decomposition accelerator and the exothermic agent is preferably 2/3 or less.

The particle diameter of a decomposition accelerator and an exothermic agent are preferably 1 mm or less for the same reason as described about the particle diameter of an onium salt containing an oxidizing anion. Since if the particle diameter is made fine, the surface area is increased and the reactivity with an adhesive is improved and the dispersibility in the adhesive is improved, the particle diameter is more preferably 100 μm or less, much more preferably 50 μm, still more preferably 20 μm, even more preferably 10 μm, and yet more preferably 5 μm or less.

The locations for use of the adhesive according to the present invention are not especially limited, but the adhesive can be used for applications of recycle, reuse and rework, and can suitably be used for the adhesion of different materials such as a metal-FRP and a metal-glass. The adhesive can also be used for the adhesion of a different metal-metal and a different FRP-FRP.

### EXAMPLES

### Preparation of Adhesives

As a structural adhesive, a broadly used epoxy resin adhesive was used. The epoxy resin used was prepared as follows.

(a) A bisphenol F epoxy as a base resin (made by Adeka Corp., trade name: Adeka Resin EP-4901), and (b) a modified aliphatic polyamine as an amine hardener (made by Adeka Corp., trade name: Adeka Hardener EH-463) were used. The composition formulation for adhesion and curing was such that a/b=76.6/23.4 was mixed to make an adhesive composition (1) (base adhesive).

(b) The modified aliphatic polyamine and (d) ammonium perchlorate were mixed to obtain a reaction product for use as a disassembling component.

In order to demonstrate advantages of the present invention, the following adhesives 1 to 5 were prepared as shown in Table 1.

### Adhesive 1

Adhesive 1 was obtained by curing the base adhesive (1) alone at 25° C. for 1 day.

### Adhesive 2

Adhesive 2 was obtained by blending ammonium perchlorate (particle diameter: 10 μm) with the base adhesive (1) in a ratio of 10/100, and curing the mixture at 25° C. for 1 day.

### Adhesive 3

Ammonium perchlorate (particle diameter: 10 μm) was mixed with the hardener (b) in a composition formulation ratio of 10/23.4, and allowed to react at 50° C. for 2 hours to obtain a mixture of a disassembling component and a hardener. Adhesive 3 was obtained by mixing the mixture with the base resin (a), and thereafter curing the resultant mixture at 25° C. for 1 day.

### Adhesive 4

Potassium perchlorate (particle diameter: 10 μm) was blended with the base adhesive (1) in a ratio of 10/100, and Adhesive 4 was obtained by curing the resultant mixture at 25° C. for 1 day.

### Adhesive 5

Ammonium perchlorate (particle diameter: 10 μm) was mixed with the hardener (b) in a composition formulation ratio of 20/10, and allowed to react at 50° C. for 2 hours to obtain a disassembling component. Adhesive 5 was obtained by blending the disassembling component with the base adhesive (1) in a ratio of 10/100, and curing the resultant formulation at 25° C. for 1 day.

Further, all Adhesives were subjected to aging at 120° C. for 1 hour after curing in order to remove the internal stress.

TABLE 1

| | Ad- | Ad- | Ad- | | |
|---|---|---|---|---|---|
| | hesive 1 | hesive 2 | hesive 3 | Adhesive 4 | Adhesive 5 |
| Base resin | 76.6 | 76.6 | 76.6 | 76.6 | 76.6 |
| Hardener | 23.4 | 23.4 | 23.4 | 23.4 | 23.4 |
| Ammonium | — | 10.0 | 10.0 | — | — |
| perchlorate | | | | | |
| Potassium | — | — | — | 10.0 | — |
| perchlorate | | | | | |
| Dissembling | — | — | — | — | 10.0 |
| component | | | | | |
| Reactoin | — | — | 50° C. | — | — |
| temperature | | | | | |

### <Measurement of the Reaction Ratio of the Disassembling Component>

The weights before and after the reaction of ammonium perchlorate and the modified aliphatic polyamine were measured, and the reaction ratio was determined by calculating a gas amount produced by the reaction from the difference between the weights.

### <Measurement of the Adhesive Strength>

The measurement of the adhesive strength was conducted as follows. An Adhesive was applied onto end portions (length: 12.5 mm, width: 25 mm) of metal plates (made of SUS) 25 mm wide, 100 mm long and 1.6 mm thick before curing thereof, and the metal plates were laminated to obtain a sample. The tensile strength (strength before heating) of the obtained sample was measured at a temperature of 25° C. and at a tensile rate of 5 mm/min. The measurement result is shown in Table 2.

### <Peeling Test in an Electric Furnace>

Heating during the peeling test was performed using an electric furnace. A test specimen was put in the heating furnace in an atmosphere of 280° C., and heated for 30 min. The tensile strength (strength after heating) was obtained under the same test condition as in the above. The test was conducted using the following testing machine.

### (Testing Machine)

SHIMADZU AGS-J (made by Shimadzu Corp.), load cell: 1 ton (10,000 N)

### <Degree of Carbonization>

The degree of carbonization of the Adhesive after the peeling test in an electric furnace was evaluated according to the following standard.

A: carbonized, no glossiness

B: not carbonized, presence of glossiness and transparency, discolored to brown

### Comparative Example 1

A bonded structural body sample adhered with the base composition of Adhesive 1 was heated at 280° C., and the degree of peeling by heating was examined. The result is shown in Table 2. As a result of the test, there was no peeling (the evaluation in this case was expressed as “absent” in the column for the presence/absence of peeling in Table 2). The degree of carbonization was B.

### Comparative Example 2

A bonded structural body sample adhered with Adhesive 2 was cured, and subjected to a tensile test to measure the strength; and the measurement revealed a decrease in the initial strength as compared with Adhesive 1. The presence of fine air bubbles was observed in the adhesive on the peeled surface. The result is shown in Table 2. The result demonstrated that in the case where an adhesive and a salt composed of an oxidizing anion reactive with a hardener and a nonmetallic cation were simultaneously mixed, the reaction of the salt composed of the oxidizing anion and the nonmetallic cation with the hardener, and the reaction of the hardener with a base resin simultaneously occurred, resulting in foaming and a decrease in the initial strength. The sample was heated at 280° C., and the degree of peeling by heating was examined. The result is shown in Table 2. A test sample was observed to peel at 30 min after the sample was put in an electric furnace (the evaluation in this case was expressed as “present” in the column for presence/absence of peeling in Table 2). The degree of carbonization was A.

### Example 1

A bonded structural body sample adhered with Adhesive 3 was subjected to a tensile test after curing to measure the strength; and the measurement obtained an initial strength similar to Adhesive 1. The result is shown in Table 2. Further, the sample was heated at 280° C., and the degree of peeling by heating was examined. Peeling was observed at 30 min after the sample was put in an electric furnace. The degree of carbonization was A. The reaction ratio of the disassembling component at this time was 90%.

### Comparative Example 3

A bonded structural body sample adhered with Adhesive 4 was subjected to a tensile test after curing to measure the strength; and the measurement obtained an initial strength similar to Adhesive 1. The result is shown in Table 2. Further, the sample was heated at 280° C., and the degree of peeling by heating was examined. Peeling was not observed even at 30 min after the sample was put in an electric furnace. The degree of carbonization was B.

### Example 2

A bonded structural body sample adhered with Adhesive 5 was subjected to a tensile test after curing to measure the strength; and the measurement obtained an initial strength similar to Adhesive 1. The result is shown in Table 2. Further, the sample was heated at 280° C., and the degree of peeling by heating was examined. Peeling was observed at 30 min after the sample was put in an electric furnace. The degree of carbonization was A. The reaction ratio of the disassembling component was 92%.

TABLE 2

| Formulation | Comparative | Comparative | Comparative | | |
|---|---|---|---|---|---|
| composition | Example 1 | Example 2 | Example 3 | Example 1 | Example 2 |
| Presence/absence of | absent | present | absent | present | present |
| peeling | | | | | |
| Peeling time | — | 30 min | — | 30 min | 30 min |
| Degree of | B | A | B | A | A |
| carbonization | | | | | |
| Strength before | 11.9 | 6.9 | 9.6 | 11.7 | 11.5 |
| heating (MPa) | | | | | |
| Strength after | 8.6 | — | 4.4 | — | — |
| heating (MPa) | | | | | |
| Reaction ratio | — | — | — | 90% | 92% |

The present invention has been described in detail and with reference to the specific embodiments, but it is obvious to those skilled in the art that various changes and modifications may be made without departing from the spirit and scope of the present invention.

### INDUSTRIAL APPLICABILITY

Use of a disassemblable adhesive using the disassembling component according to the present invention can suppress foaming in an adhesive using an amine hardener, and can reduce the decrease in the initial strength. Further, the use thereof enables a bonded structural body adhered with the adhesive to be easily disassembled by an external stimulus. Therefore, the adhesive according to the present invention is useful for applications of recycle, reuse and rework, and can suitably be used for adhesion of different materials such as a metal-FRP and a metal-glass.

1. A disassemblable adhesive comprising:
an organic adhesive component; and
a reaction product obtained by reacting an onium salt containing an oxidizing anion with an amine group of an amine compound so that the reaction ratio thereof becomes 50% or higher.

2. The disassemblable adhesive according to claim 1, wherein the organic adhesive component is an organic adhesive component containing an amine group.

3. The disassemblable adhesive according to claim 1, wherein the organic adhesive component comprises an epoxy or urethane base resin, and an amine hardener.

4. The disassemblable adhesive according to claim 1, wherein the onium salt is at least one selected from the group consisting of perchlorates, chlorates, nitrates and nitrites.

5. A structural body, obtained by binding an adherend part A and an adherend part B with a disassemblable adhesive according to claim 1.

6. A method for disassembling a structural body according to claim 5, comprising eliminating or reducing an adhesive strength by an external stimulus.

7. The method for disassembling a structural body according to claim 6, wherein the external stimulus is heating.

8. The disassemblable adhesive according to claim 2, wherein the organic adhesive component comprises an epoxy or urethane base resin, and an amine hardener.

9. A structural body, obtained by binding an adherend part A and an adherend part B with a disassemblable adhesive according to claim 2.

10. A method for disassembling a structural body according to claim 9, comprising eliminating or reducing an adhesive strength by an external stimulus.

11. The method for disassembling a structural body according to claim 10, wherein the external stimulus is heating.

12. A structural body, obtained by binding an adherend part A and an adherend part B with a disassemblable adhesive according to claim 3.

13. A method for disassembling a structural body according to claim 12, comprising eliminating or reducing an adhesive strength by an external stimulus.

14. The method for disassembling a structural body according to claim 13, wherein the external stimulus is heating.

15. A structural body, obtained by binding an adherend part A and an adherend part B with a disassemblable adhesive according to claim 4.

16. A method for disassembling a structural body according to claim 15, comprising eliminating or reducing an adhesive strength by an external stimulus.

17. The method for disassembling a structural body according to claim 16, wherein the external stimulus is heating.

18. A structural body, obtained by binding an adherend part A and an adherend part B with a disassemblable adhesive according to claim 8.

19. A method for disassembling a structural body according to claim 18, comprising eliminating or reducing an adhesive strength by an external stimulus.

20. The method for disassembling a structural body according to claim 19, wherein the external stimulus is heating.
